(19) United States
(12) Patent Application Publication
(10) Pub. No.: US 2025/0096655 A1
(43) Pub. Date: Mar. 20, 2025

(54) STATOR ARRANGEMENT FOR AN ELECTRICAL MACHINE AND METHOD FOR MANUFACTURING THEREOF

(71) Applicant: ebm-papst Mulfingen GmbH & Co. KG, Mulfingen (DE)

(72) Inventors: Martin Baun, Mulfingen (DE); Nils Trumpf, Bretzfeld-Schwabbach (DE)

(21) Appl. No.: 18/890,184

(22) Filed: Sep. 19, 2024

(30) Foreign Application Priority Data
Sep. 20, 2023 (DE) 10 2023 125 440.5

(51) Int. Cl. H02K 11/25; G01K 1/02; G01K 1/14; H02K 1/14

(52) U.S. Cl. CPC H02K 11/25; G01K 1/026; G01K 1/14; H02K 1/146

(57) ABSTRACT

The present disclosure refers to a stator arrangement as well as a method for the manufacturing thereof. The stator arrangement has a stator body having a stator core that is entirely or partly coated by an electrically insulating coating layer. A temperature-sensitive measurement conductor path is arranged in or on the coating layer and is integrally realized together with the coating layer. For this purpose, an MID manufacturing method can be used, for example. The at least one temperature-sensitive measurement conductor path has a temperature-dependent resistance. It is preferably arranged at a measurement position between a tooth of stator body and a stator winding wound onto the tooth.

### CROSS REFERENCE TO RELATED APPLICATIONS

This application claims priority under 35 U.S.C. § 119 to the following German Patent Application No. 10 2023 125 440.5, filed on Sep. 20, 2023, the entire contents of which are incorporated herein by reference thereto.

### TECHNICAL FIELD

The present disclosure refers to a stator arrangement for an electrical machine, particularly an electric motor, as well as a method for the manufacturing thereof.

### BACKGROUND

An electric motor is known from WO 2020/167124 A1 in which the ohmic winding resistance of a stator winding is determined. For example, the winding resistance can then be used for determination of the rotational speed of the electric motor by means of measurement of the motor current. For example, from the winding resistance also the motor temperature can be determined, for example, in order to protect the electric motor from too high temperatures. In order to determine the temperature-dependent winding resistance, a temperature sensor is used. In addition, also a voltage sensor and a current sensor can be present, wherein all of the sensors communicate with an evaluation unit, in which then the temperature-dependent winding resistance can be determined.

A measurement method for determination of a motor winding resistance is also described in WO 2022/131455 A1. Based on the determined winding resistance, then the winding temperature can be calculated.

DE 10 2007 046 227 A1 discloses an electric motor. The stator arrangement uses at least partly an MID-technology (Molded Interconnected Devices). In doing so, it shall be simpler to combine a number of usually used components, such as a ring circuit board, a control electronic, a sensor support, and a base plate of the electric motor in order to reduce the mounting costs and the production costs. The MID-technology is, for example, also proposed in EP 2 589 817 B1 for manufacturing a housing part having conductor paths for a pump unit.

Starting from the prior art, it can be considered as object of the present disclosure to provide a stator arrangement that allows a precise temperature determination and can thereby be manufactured concurrently in a simple and economic manner.

### BRIEF SUMMARY

This object is solved by means of a stator arrangement including: a stator body having a stator core, wherein the stator body is configured for attachment of at least one stator winding, an electrically insulating coating layer that partly or entirely coats the stator core of the stator body, a temperature-determination device that comprises at least one measurement conductor path having a temperature-dependent resistance, wherein the at least one measurement conductor path is arranged on or in the coating layer. Also disclosed is a method of for manufacturing a stator arrangement for an electrical machine including: providing a stator core of a stator body, wherein the stator body is configured for attachment of at least one stator winding, producing an electrically insulating coating layer that surrounds the stator core of the stator body partly or entirely, and producing at least one measurement conductor path having a temperature-dependent resistance of a temperature determination device, wherein the at least one measurement conductor path is arranged on or in the coating layer.

The stator arrangement has a stator body comprising a stator core and a coating layer coating the stator core partly or completely. The stator body is configured for attachment of at least one stator winding. For this purpose, the stator body can comprise teeth around which the windings are wound. The teeth are distanced in circumferential direction by means of winding grooves.

The stator core consists of an electrically conductive material. Along a longitudinal axis (that defines a rotation axis of a rotor, for example) the stator core can be built up by individual electrically conductive metal sheet parts and can therefore be denoted as stator package.

The coating layer is applied on the stator core that encloses the stator core partly or entirely. The coating layer is electrically insulating. The coating layer is particularly present on the teeth in order to electrically insulate the stator windings from the stator core.

The stator arrangement has in addition a temperature determination device. The temperature determination device is configured to determine a temperature on the stator body. Particularly the temperature is not directly measured, but determined indirectly based on one or more measured or otherwise determined electrical parameters. The temperature determination device comprises for this purpose at least one measurement circuit branch having at least one measurement conductor path, respectively. Each measurement conductor path has a temperature-dependent resistance. This resistance can have an NTC characteristic (NTC thermistor) or a PTC characteristic (PTC thermistor). For this purpose, the at least one measurement conductor path can comprise material having a suitable characteristic or can preferably exclusively consist of such a material.

Preferably in each measurement circuit branch-apart from the at least one measurement conductor path-no additional electrical and/or electronic components are present.

The at least one measurement conductor path is arranged on or in the coating layer. It is particularly integrated on or in the coating layer, so that a non-destructive separation of the at least one measurement conductor path from the coating layer is impossible. The at least one measurement conductor path and the coating layer can be an integral unit, so-to-speak.

The at least one measurement conductor path can be electrically connected with an evaluation unit of the temperature determination device. For example, the evaluation unit can be arranged on a support (for example, circuit board) and can be attached to the stator body. On the support also additional control components and/or circuit parts for control of the operation of an electrical machine, which comprises the stator arrangement, can be present.

The stator arrangement, according to the present disclosure, having the temperature determination device, requires only few components and can be realized as compact, highly integrated stator arrangement. The manufacturing of the coating layer and the at least one measurement conductor path can be carried out very economically, for example, by means of an MID method, such as two-component injection molding or a laser MID method. The abbreviation MID stands for the English expression “Molded Interconnected Devices”. For example, a Laser Direct Structuring (LDS) or a subtractive laser structuring can be used as laser MID method.

The at least one measurement conductor path is preferably arranged in the area of a face of the stator body and/or in the area of a tooth flank inside the winding groove of the stator body. The at least one measurement conductor path is particularly electrically insulated from the stator core, preferably by means of the coating layer. The number of measurement conductor paths and thus the number of measurement positions at which a temperature can be determined on the stator body by means of the temperature determination device can be selected arbitrarily and can be varied in simple manner. The stator arrangement can be highly flexibly configured in this regard. Thus, the possibility is offered to detect the temperature at one or more stator windings at a position directly adjacent to the stator winding. The temperature determination is therefore very precise. Measurement errors due to unfavorable or erroneous positioning of a temperature sensor (for example due to an assembly error) can be avoided by means of the present disclosure in a very simple manner.

The temperature determination device is particularly configured to determine the resistance value of the at least one measurement conductor path, for example, by applying of an impressed voltage to the at least one measurement conductor path and by determination of the current flowing through the at least one measurement conductor path. Alternatively to this, the temperature determination device can also be configured to impress a current for the at least one measurement conductor path and to determine the voltage resulting at the measurement conductor path. The resistance value results from Ohm's law. Because the temperature dependency (temperature characteristic) of the resistance of the at least one measurement conductor path is known, the temperature at the at least one measurement conductor path can be determined based on a respective attribution (function, table, etc.).

In this application the term “resistance” means an ohmic resistance as long as nothing else is indicated.

As mentioned above, the at least one measurement conductor path is inseparably connected with the coating layer, preferably by means of a substance bond. It is advantageous, if the mechanical connection between the coating layer and the at least one measurement conductor path is created during and by the manufacturing of the coating layer and/or during and by the manufacturing of the at least one measurement conductor path. For example, the coating layer can be an injection molded layer and the at least one measurement conductor path can be manufactured based on a known MID method on or in the coating layer—as mentioned above. The coating layer can be an injection molded conductor path support. The at least one conductor path can be particularly manufactured during the manufacturing of the coating layer or subsequently by means of an additional process.

All present measurement circuit branches and measurement conductor paths are present on or in the coating layer. The electrical connection to an evaluation unit of the temperature detection device can be realized outside or on or in the coating layer. Optionally, also the evaluation unit can be arranged on the coating layer. The coating layer is in this case an injection molded circuit support.

It is advantageous, if the temperature determination device comprises multiple measurement conductor paths that are spatially arranged with distance to each other at different measurement positions on the stator body. In doing so, individual temperature values at multiple measurement positions can be determined or an average value of the temperature can be determined for the multiple measurement positions. For example, this depends on how the multiple measurement conductor paths are electrically connected with one another. An individual measurement position is thereby particularly a position on the stator body to which an individual stator winding on a tooth is assigned in order to determine the temperature of the stator winding.

Preferably, the temperature determination device can comprise at least one measurement circuit branch, wherein each measurement circuit branch comprises precisely one measurement conductor path or multiple measurement conductor paths. For each measurement circuit branch, the temperature determination device can determine an individual parameter characterizing a temperature of the measurement circuit branch.

Each measurement circuit branch can be assigned to exactly one measurement position or different measurement conductor paths of a measurement circuit branch can be arranged at measurement positions arranged with spatial distance.

In all embodiments it can be advantageous, if multiple or all of the present measurement conductor paths are connected in series and/or parallel to one another.

Each measurement circuit branch has two electrical connections in order to electrically connect the measurement circuit branch to a voltage source and/or a current source. One of these electrical connections or both electrical connections of each measurement circuit branch are preferably arranged in the area of a face of the stator body in order to guarantee a good position for connecting the evaluation unit of the temperature determination device. Thereby, all of the connections are preferably present on the same face. One connection of each measurement circuit branch can be connected to a common reference potential, particularly ground potential, and for this purpose can be optionally connected with a conductive part of the stator arrangement, for example, the stator core. In this case, guiding a connection connected to the common reference potential of the measurement circuit branch to the face of the stator body is not necessary.

In the preferred embodiment, the measurement conductor path or at least one of the provided measurement conductor paths can be arranged at the following positions on the stator body:
the respective measurement conductor path can be arranged only in the area of a face of the stator body;
the respective measurement conductor path can be arranged only in the area of a tooth flank inside a winding groove of the stator body;
the respective measurement conductor path can be arranged in the area of the two tooth flanks of a common tooth inside the two adjacent winding grooves of the stator body;
the measurement conductor path can be arranged along a tooth flank inside a winding groove with one section as well as in the area of the face of the stator body with another section.

The geometry and the extension of the at least one measurement conductor path can be defined depending on the temperature to be determined. For example, the arrangement of the at least one measurement conductor path can be dependent from whether the temperature shall be determined at a locally limited position of the winding (for example winding head) or whether a temperature average value shall be determined along a longer section of the winding (for example inside one single winding groove) or along the entire winding.

The cross-section of each measurement conductor path can be round, for example circular, polygonal and for example rectangular. Preferably, the cross-section form of a measurement conductor path is constant along its extension. In sections along its extension, the measurement conductor path can be straight, and/or curved, and/or arc-shaped. For example, a measurement conductor path can be a polygonal line or can comprise straight sections that are respectively connected to one another by means of an arc-shaped or circular arc-shaped section.

In an embodiment the measurement conductor path can have a meandering and/or zig-zag-shaped extension at the measurement position. In doing so, the possibility exists to make the measurement conductor path long in current flow direction with concurrently low surface space required. Particularly the length of the measurement conductor path in current flow direction can be longer at the measurement position than an outer circumferential line that defines and limits the measurement position. For example, the length of the measurement conductor path at the measurement position can be at least about the factor 3 to 5 longer than the length of the outer circumferential line that defines or limits the measurement position.

Any embodiment of the stator arrangement can be manufactured as follows:

First, a stator core is provided. Subsequently, an electrically insulating coating layer is applied to the stator core, preferably by means of an injection molding method. The stator core is so-to-speak partly or entirely overmolded and in doing so, forms the stator body.

The measurement conductor path is either already manufactured during manufacturing of the coating layer or subsequently by means of an additional method step on or in the coating layer so that the coating layer serves as support for the at least one measurement conductor path. Particularly, the coating layer and the at least one measurement conductor path can form a unit that cannot be separated non-destructively.

Subsequently, the required electrical connections can be realized. Particularly, the at least one measurement conductor path is electrically connected with an evaluation unit of the temperature determination device. Depending on whether the evaluation unit supplies an impressed voltage or an impressed current, the respective other parameter (that means the current or the voltage) can be measured or determined in another manner and based on Ohm's law, the resistance of the at least one measurement conductor path can be determined. This resistance is characterizing for a temperature at the measurement position at which the at least one measurement conductor path is arranged.

### BRIEF DESCRIPTION OF THE DRAWINGS

Advantageous embodiments of the present disclosure are derived from the dependent claims, the description and the drawing. In the following, preferred embodiments of the present disclosure are explained in detail based on the attached drawing. The drawing shows:

FIG. 1 an embodiment of a stator arrangement in a perspective view,

FIG. 2 an embodiment of a stator core for the stator arrangement of FIG. 1 in a perspective view,

FIGS. 3 to 5 a schematic basic illustration for different configurations of a measurement conductor path on a tooth of the stator body of FIG. 2 respectively,

FIGS. 6 and 7 a basic illustration in cross-section through a part of the stator body respectively in which a measurement conductor path is arranged in or on a coating layer on the stator body,

FIG. 8 a circuit diagram of an embodiment of a temperature determination device of the stator arrangement of FIG. 1 and

FIGS. 9 and 10 basic illustrations for different configurations of measurement circuit branches of the temperature determination device of FIG. 8 respectively.

### DETAILED DESCRIPTION

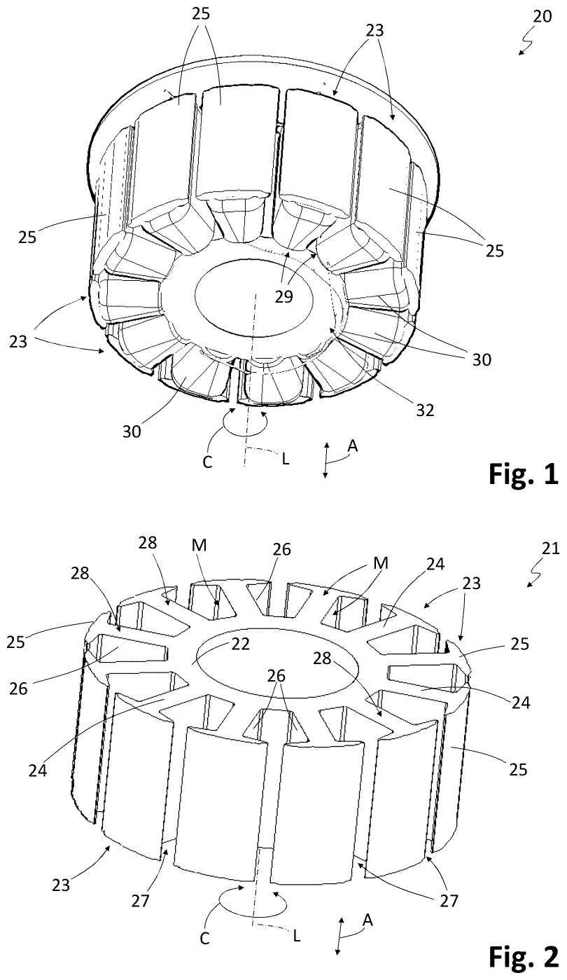

An embodiment of a stator arrangement 20 is perspectively illustrated in FIG. 1. The stator arrangement 20 is provided for use in an electrical machine, for example an electric motor. In the stator arrangement 20 illustrated in FIG. 1, the rotor is coaxially arranged outside of the stator arrangement (external rotor). Alternatively to this, the stator arrangement 20 could also be configured for an electrical machine with internal rotor.

The stator arrangement 20 has a stator core 21, separately illustrated in FIG. 2. The stator core 21 defines a longitudinal axis L, which is the rotational axis of the assigned rotor when used in an electrical machine. In the embodiment, stator core 21 has a ring part 22 surrounding the longitudinal axis L in a circumferential direction C.

Stator core 21 comprises teeth 23 uniformly distributed and arranged with distance to one another in circumferential direction C that extend radially outwardly in the embodiment. The teeth 23 have the same geometry or shape respectively. They have a tooth web 24 and a tooth head 25. The tooth web 24 connects the tooth head 25 with ring part 22. In the embodiment, tooth webs 24 have a smaller dimension than the tooth heads 25 in circumferential direction C. The tooth heads 25 project in circumferential direction C at both sides away from tooth web 24. Thereby, each tooth 23 has a T-shaped form with view in axial direction A parallel to the longitudinal axis L. Each tooth web 24 has two tooth flanks 26 that can be configured as planar surfaces. The tooth flanks 26 are, according to the example, arranged in a plane that is defined by the axial direction A and a direction extending orthogonal to the axial direction A.

The tooth flanks 26 of teeth 23 that are directly adjacent in circumferential direction C are facing a common winding groove 27 between these two adjacent teeth 23.

In axial direction A each tooth 23 has two faces 28. In the embodiment faces 28 are arranged in a plane respectively that is orientated orthogonal to the longitudinal axis L.

The stator core 21 can be formed of a plurality of stator sheet parts stacked in axial direction A on top of each other and that have the same outer contour respectively. The stator core 21 can therefore also be denoted as stator package. The stacked stator sheet parts are electrically insulated from one another in order to reduce an eddy current creation.

Each tooth 23 of stator core 21 serves for arranging a stator winding 29 (FIG. 1). The stator windings 29 are wound around an assigned tooth web 24. Thus, each stator winding 29 extends in sections in two winding grooves 26, which are directly adjacent in circumferential direction C, and projects at the faces beyond the faces 28 and forms respectively one winding head 30 there. In FIG. 1, substantially the winding head 30 of the stator windings 29 is visible.

The stator windings 29 can be electrically connected in series and/or in parallel depending on the configuration of the stator arrangement 20, depending on the arrangement and the number of strands of the stator arrangement. For example, respectively four stator windings 29 can be electrically connected to one strand respectively.

The stator core 21 is partly or entirely coated by means of an insulating coating layer 31 and forms together with coating layer 31 a stator body 32 (FIG. 1) the coating layer 31 can be continuous or can also have multiple areas, which are spatially separated from each other. The coating layer 31 can preferably be applied onto the stator core 21 by means of an injection molding method. The coating layer 31 is particularly configured to electrically insulate stator core 21 from stator windings 29.

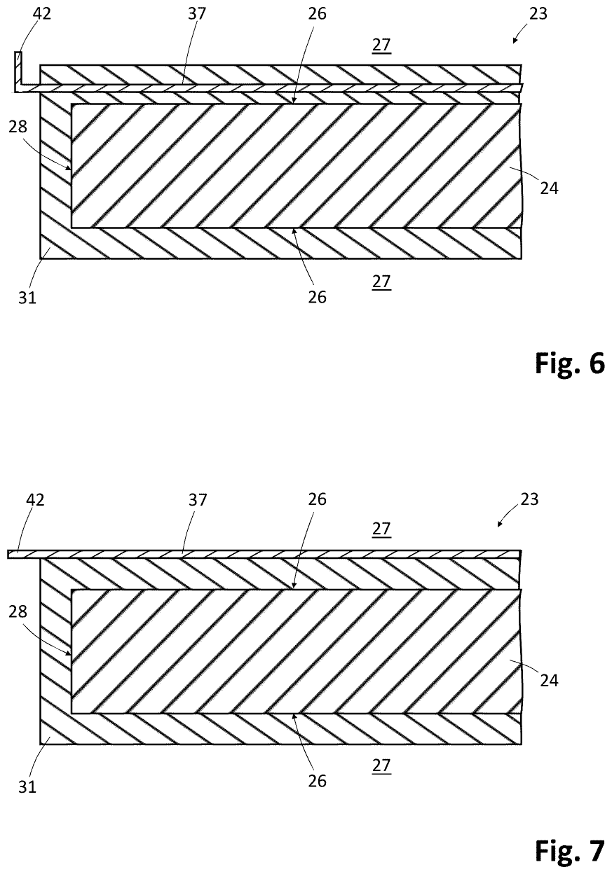

The coating layer 31 is schematically illustrated in FIGS. 6 and 7. FIGS. 6 and 7 show, by way of example and in part, a sectional plane through the tooth 23, for example the tooth web 24, on which the insulating coating layer 31 is applied on the outer side.

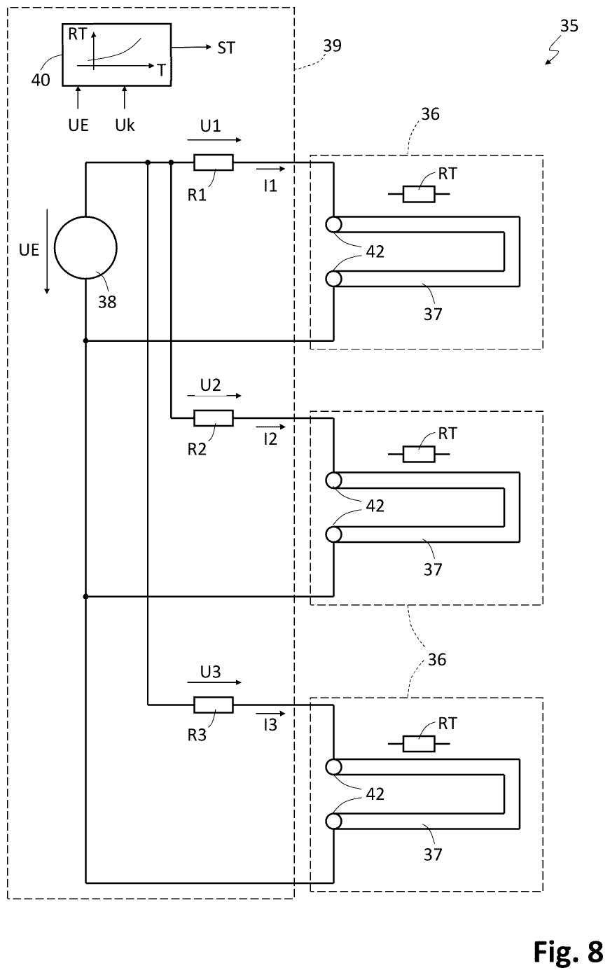

The stator arrangement 20 has a temperature determination device 35 (FIG. 8), which is configured to determine one or more temperature values, wherein each temperature value describes a temperature T at one or more measurement positions M (FIG. 2) of stator arrangement 20.

Each measurement position M is arranged on a tooth 23. The measurement position M can be located on the face in the area of faces 28 or inside the winding groove 27 in the area of a tooth flank 26. The number of measurement positions M is arbitrary. Depending on the configuration of the temperature determination device 35, an individual temperature value of temperature T can be determined for each measurement position M or a temperature value can be determined for multiple measurement positions M that describes a statistic value at the measurement positions M, such as an average temperature.

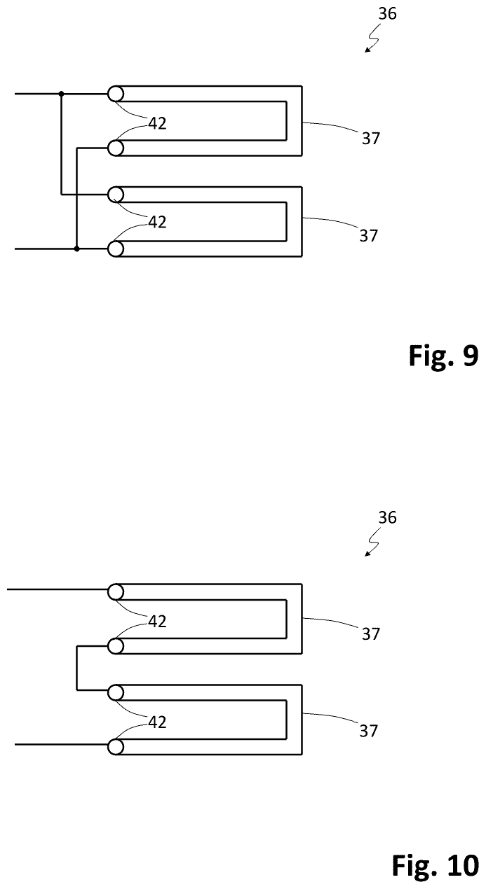

The temperature determination device 35 has one or more measurement circuit branches 36 (FIG. 8). Each measurement circuit branch 36 comprises at least one measurement conductor path 37. In the embodiment illustrated in FIG. 8 each measurement circuit branch 36 has exactly one measurement conductor path 37. In each measurement circuit branch 36, also multiple measurement conductor paths 37 can be provided as shown in FIGS. 9 and 10. The measurement conductor paths 37 can be electrically connected with each other in parallel connection (FIG. 9) or in series connection (FIG. 10).

Each measurement conductor path 37 comprises a temperature-dependent resistance RT. For this purpose, the measurement conductor path 37 can comprise a suitable material or can consist of a suitable material. For example, materials such as platinum, nickel, metallic alloys or silicon can be used. The temperature-dependent resistance RT can comprise a Positive Temperature Coefficient (PTC) or a Negative Temperature Coefficient (NTC) and thus can be configured as PTC thermistor or NTC thermistor. In the embodiment, all of the measurement conductor paths 37 have the same characteristic and can particularly consist of the same material. Alternatively to this, it is also possible to manufacture multiple measurement conductor paths 37 from different materials and/or configure multiple measurement conductor paths 37 with different temperature-resistance-characteristics.

In the embodiment of the temperature determination device 35 shown in FIG. 8, three measurement circuit branches 36 are illustrated by way of example. The number of measurement circuit branches 36 can be higher or lower in modification to this. Preferably, exactly one measurement position M on the stator body 32 is assigned to each measurement circuit branch 36. The at least one measurement circuit path 37 of the measurement circuit branch 36 is thus positioned at the assigned measurement position M.

An individual measurement position M can be, for example, an individual tooth 23 or also a section of a single tooth 23, such as one of the tooth flanks 26 or the face 28 of a tooth 23. Preferably, an individual measurement position M is assigned to exactly one stator winding 29 arranged on an individual tooth 23 of stator body 32.

In the embodiment depicted in FIG. 8, temperature determination device 35 is configured to apply an input voltage UE (impressed voltage) to each measurement circuit branch 36. For this purpose, the measurement circuit branches 36 can be connected parallel to each other to an input voltage source 38 of an evaluation unit 39.

A measurement resistor Rk of evaluation unit 39 can be connected in series to each measurement circuit branch 36, wherein a voltage Uk is applied to each measurement resistor Rk, characterizing a current Ik flowing through the respective measurement circuit path 36, wherein k=1, 2, 3, etc. is an index corresponding to the number of the provided measurement circuit branches 36.

For the measurement branches illustrated exemplarily in FIG. 8, evaluation unit 39 therefore comprises a first measurement resistor R1, a second measurement resistor R2 and a third measurement resistor R3 that are respectively connected in series to an assigned measurement circuit branch 36. The measurement resistors R1, R2, R3 are connected with the input voltage source 38 respectively. A first voltage U1 is applied to the first measurement resistor R1, characterizing a first current I1 through the first measurement resistor R1. Analog to this, a second voltage U2 is applied to the second measurement resistor R2, characterizing a second current I2 through the second measurement resistor R2. Analog to this, a third voltage U3 is applied to the third measurement resistor R3, characterizing a third current I3 through the third measurement resistor R3.

The input voltage UE is known. By determining the currents I1, I2, I3 or the voltages U1, U2, U3 characterizing the currents, a temperature value WT can be determined in the evaluation unit 39 of the temperature determination device 35, wherein the temperature value WT is characteristic for a temperature T of the stator arrangement 20 at the respective measurement circuit branch 36. For this purpose, based on Ohm's law, the value of the temperature-dependent resistance RT can be determined in the evaluation unit 39 and then—from the known correlation between the temperature and the temperature-dependent resistance RT of the measurement conductor path 37—the temperature T can be determined that is associated with the value of the temperature-dependent resistance RT. For this purpose, the evaluation unit 39 can generate a temperature signal ST characterizing this temperature T. The temperature signal ST can be processed further or can be transmitted to a user interface (for example display) and can be indicated to an operator person or can be used and/or processed further in another manner. For example, the temperature of the stator arrangement 20 can be monitored, and a warning can be created in case of exceeding a temperature limit value. Also, measures for reducing the temperature can be initiated.

In order to determine the temperature T and/or to create the temperature signal ST, the evaluation unit 39 can comprise a module 40 that is configured to determine the temperature T based on the known correlation between the input voltage UE and a parameter (for example voltage Uk) characterizing the current Ik. For this purpose, the module 40 can comprise a function, a lookup table, a characteristic line, a characteristic diagram or the like. The module can particularly comprise a computing device (for example a microprocessor) and, as an option, a data memory.

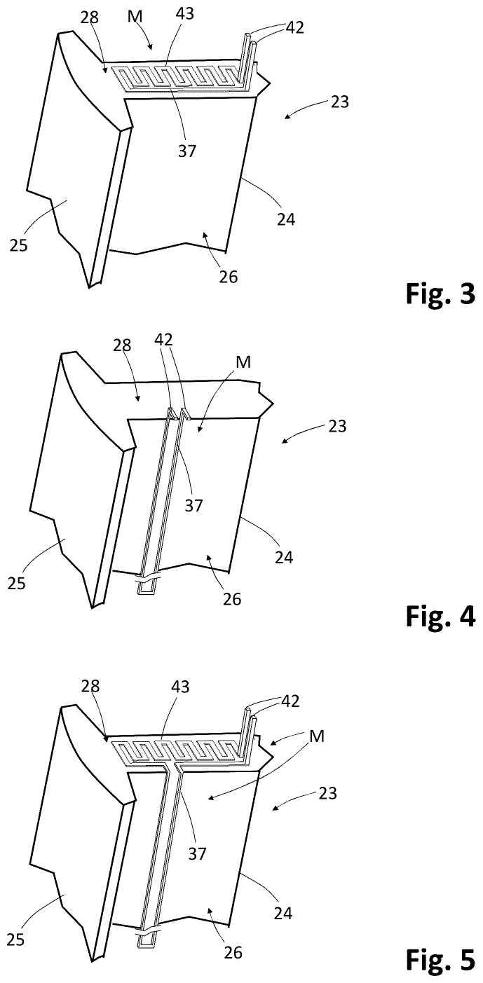

In FIGS. 3 to 5 the arrangement of a measurement conductor path 37 at a measurement position M is schematically illustrated respectively. In the embodiment shown in FIG. 3, a measurement conductor path 37 is arranged at a measurement position M in the area of a face 28 of a tooth 23. FIG. 4 shows an embodiment of a measurement conductor path 37 that is arranged in the area of a tooth flank 26 of a tooth 23. FIG. 5 depicts a combination of the embodiments according to FIGS. 3 and 4 so-to-speak, wherein the measurement conductor path 37 has a conductor path section in the area of the face 28 and a conductor path section in the area of the tooth flank 26 of tooth 23. In all embodiments illustrated in FIGS. 3 to 5, each measurement conductor path 37 has two electrical connections 42 that are arranged in the area of the face 28 of tooth 23. This allows a simple electrical connection of the respective measurement conductor path 37 in the temperature determination device 35.

In the embodiments illustrated in FIGS. 3 to 5, each measurement conductor path 37 has multiple straight sections or webs arranged adjacent to one another. In the connection area between two directly connected webs or sections, the measurement conductor path 37 forms a kink. In the illustrated embodiments the kink has an absolute value of 90° in each case. Additionally or alternatively to the illustrated embodiments, each measurement conductor path 37 could also be arc-shaped or curved in sections. For example, the kinks could also be replaced by arcs, particularly circular arcs, which connect two straight extending sections with each other. The geometry or the extension of each measurement conductor path 37 between the connections 42 can be selected arbitrarily in general.

A very simple example of a measurement conductor path 37 is illustrated in FIG. 4. Here, the measurement conductor path 37 has two sections or webs extending parallel to one another that are connected with an assigned electrical connection 42 on one side and with another section or web on the other side. The measurement conductor path 37 is U-shaped, so-to-speak.

In order to achieve a sufficient conductor length in direction of the current flow between the two connections 42 in the light of the available area at an individual measurement position M, the measurement conductor path 37 can comprise a meander-shaped conductor path section 43, as exemplarily depicted in FIGS. 3 and 5. The meander-shaped conductor path section 43 is here arranged in the area of face 28 of tooth 23. Additionally or alternatively, a meander-shaped conductor path section 43 could also be arranged on a tooth flank 26. The length of the meander-shaped conductor path section 43 in current flow direction is remarkably longer than the length of the outer contour surrounding the measurement position M extending around the meander-shaped conductor path section 43. In doing so, the effective conductor length of measurement conductor path 37 at the measurement position M can be very long, also if the length and the width of the measurement position M (outer contour) is small. This allows a higher flexibility for dimensioning the temperature-dependent resistance RT and/or the material selection of the measurement conductor path 37.

Each measurement conductor path 37 is arranged in the coating layer 31 (FIG. 7) or inside the coating layer 31 (FIG. 6) the at least one measurement conductor path 37 is an integral part of the coating layer 31 and cannot be separated from the coating layer 31 in non-destructive manner. The at least one measurement conductor path 37 is connected during its manufacturing or during the manufacturing of the coating layer 31 with the coating layer 31 in substance bond manner. Preferably, an MID manufacturing method is used for manufacturing of the coating layer 31 together with the at least one measurement conductor path 37. The abbreviation “MID” thereby stands for the English expression “Molded Interconnected Devices”. Thereby, methods can be used such as a two-component injection molding method, a laser MID method or another known MID method.

In the embedment illustrated here, coating layer 31 is manufactured by means of an injection molding method and thus forms an injection molding layer. The coating layer 31 provides an injection molded support for the at least one measurement conductor path 37. In addition or as an alternative, also other components of the temperature determination device 35 can be integrated in the coating layer 31 analog to the at least one measurement conductor path 37.

Depending on the selected MID technology, the at least one measurement conductor path 37 can be created subsequently to injection molding of the coating layer 31, for example, by exposure by means of a laser and subsequent metallization on the surface of the coating layer 31 (FIG. 7). Alternatively to this, it is also possible to create the at least one measurement conductor path 37 already during manufacturing of the coating layer 31, for example, by means of a two-component or multi-component injection molding method (FIG. 6).

In all embodiments the at least one temperature-sensitive measurement conductor path 37, forming a temperature sensor so-to-speak, is not an individual separate component, but realized with the coating layer 31 in a space saving integrated manner. The at least one measurement conductor path 37 thereby comprises a high positional accuracy. Misplacements are avoided or at least reduced. The at least one measurement conductor path 37 can be particularly arranged in or on the coating layer 31 directly adjacent to the surrounding stator winding 29 so that the temperature of the surrounding stator winding 29 can be detected very accurately.

The present disclosure refers to a stator arrangement 20 as well as a method for the manufacturing thereof. The stator arrangement 20 has a stator body 32 having a stator core 21 that is entirely or partly coated by an electrically insulating coating layer 31. A temperature-sensitive measurement conductor path 37 is arranged in or on the coating layer and is integrally realized together with the coating layer 31. For this purpose, an MID manufacturing method can be used, for example. The at least one temperature-sensitive measurement conductor path 37 has a temperature-dependent resistance RT. It is preferably arranged at a measurement position M between a tooth 23 of stator body 32 and a stator winding 29 wound onto the tooth 23.

### LIST OF REFERENCE SIGNS

20 stator arrangement
21 stator core
22 ring part
23 tooth
24 tooth web
25 tooth head
26 tooth flank
27 winding groove
28 face
29 stator winding
30 winding head
31 coating layer
32 stator body
35 temperature determination device
36 measurement circuit branch
37 measurement conductor path
38 input voltage source
39 evaluation unit
40 module
42 electrical connection Anschluss
43 meander shaped conductor path section
A axial direction
C circumferential direction
I1 first current
I2 second current
I3 third current
L longitudinal axis
M measurement position
R1 first measurement resistor
R2 second measurement resistor
R3 third measurement resistor
RT temperature dependent resistance
ST temperature signal
T temperature
UE input voltage
U1 first voltage
U2 second voltage
U3 third voltage

1. A stator arrangement for an electrical machine comprising:
a stator body having a stator core, wherein the stator body is configured for attachment of at least one stator winding,
an electrically insulating coating layer that partly or entirely coats the stator core of the stator body,
a temperature-determination device that comprises at least one measurement conductor path having a temperature-dependent resistance, wherein the at least one measurement conductor path is arranged on or in the coating layer.

2. The stator arrangement according to claim 1, wherein the at least one measurement conductor path and the coating layer are one integral unit.

3. The stator arrangement according to claim 1, wherein the at least one measurement conductor path is unreleasably connected with the coating layer.

4. The stator arrangement according to claim 1, wherein a mechanical connection between the coating layer and the at least one measurement conductor path is created by manufacturing the coating layer and/or the at least one measurement conductor path.

5. The stator arrangement according to claim 4, wherein the coating layer is an injection molded layer.

6. The stator arrangement according to claim 1, wherein the temperature determination device comprises multiple measurement conductor paths that are arranged spatially with distance to one another at different measurement positions on the stator body.

7. The stator arrangement according to claim 1, wherein the temperature determination device comprises at least one measurement circuit branch that comprises one measurement conductor path or multiple measurement conductor paths, and wherein the temperature determination device is configured to provide for each measurement circuit branch a measurement parameter respectively that describes a temperature of the measurement circuit branch.

8. The stator arrangement according to claim 6, wherein at minimum two different measurement positions, respectively one measurement circuit branch is arranged.

9. The stator arrangement according to claim 8, wherein the measurement circuit branch comprises multiple measurement conductor paths arranged at different measurement positions.

10. The stator arrangement according to claim 6, wherein each measurement circuit branch comprises two electrical connections, wherein at least one of the two electrical connections is arranged at a face of the stator body.

11. The stator arrangement according to claim 1, wherein the temperature determination device comprises multiple measurement conductor paths that are arranged electrically in parallel connection and/or in series connection.

12. The stator arrangement according to claim 1, wherein the at least one measurement conductor path is arranged on a face of the stator body and/or in a winding groove of the stator body.

13. The stator arrangement according to claim 1, wherein the at least one measurement conductor path comprises a meander-shaped conductor path section.

14. A method for manufacturing a stator arrangement for an electrical machine comprising:
providing a stator core of a stator body, wherein the stator body is configured for attachment of at least one stator winding,
producing an electrically insulating coating layer that surrounds the stator core of the stator body partly or entirely, and
producing at least one measurement conductor path having a temperature-dependent resistance of a temperature determination device, wherein the at least one measurement conductor path is arranged on or in the coating layer.

15. The method according to claim 14, wherein the coating layer and the at least one measurement conductor path are produced by means of an MID method.

16. The stator arrangement according to claim 2, wherein the at least one measurement conductor path is unreleasably connected with the coating layer.

17. The stator arrangement according to claim 16, wherein a mechanical connection between the coating layer and the at least one measurement conductor path is created by manufacturing the coating layer and/or the at least one measurement conductor path.

18. The stator arrangement according to claim 17, wherein the coating layer is an injection molded layer.

19. The stator arrangement according to claim 18, wherein the temperature determination device comprises multiple measurement conductor paths that are arranged spatially with distance to one another at different measurement positions on the stator body.

20. The stator arrangement according to claim 19, wherein the temperature determination device comprises at least one measurement circuit branch that comprises one measurement conductor path or multiple measurement conductor paths, and wherein the temperature determination device is configured to provide for each measurement circuit branch a measurement parameter respectively that describes a temperature of the measurement circuit branch.
